(19) United States
(12) Patent Application Publication
(10) Pub. No.: US 2026/0364654 A1
(43) Pub. Date: Nov. 19, 2026

(54) METHOD FOR DISPOSING AND RECYCLING AT LEAST ONE CARTRIDGE AND A DISPOSING AND RECYCLING SYSTEM

(71) Applicant: medmix Switzerland AG, Haag (Rheintal) (CH)

(72) Inventors: Tobias BODENMÜLLER, Eriskirch (DE); Christian MAJOLETH, Bonaduz (CH); Philipp SEILER, St. Gallen (CH); Rico ITEN, Sevelen (CH); Wolfgang KITZMULLER, Wolfurt (AT)

(21) Appl. No.: 19/132,585

(22) PCT Filed: Nov. 2, 2023
(86) PCT No.: PCT/EP2023/080561

§ 371 Date: May 23, 2025

(30) Foreign Application Priority Data
Nov. 30, 2022 (GB) 2218004.6

(51) Int. Cl. B09B 3/30; B09B 101/02

(52) U.S. Cl. CPC B09B 3/30; B09B 2101/02

(57) ABSTRACT

A method for disposing and recycling at least one cartridge including a cartridge container and a head part, the cartridge further being storing at least one material, includes providing a cartridge and a receptacle to receive the at least one cartridge, placing the cartridge into the receptacle such that at least an upper part of the cartridge extends beyond an upper open edge of the receptacle, and removing the upper part of the cartridge from the cartridge container, at a plane extending along the upper edge of the receptacle.

### CROSS-REFERENCE TO RELATED APPLICATION

This application is a U.S. national stage application of International Application No. PCT/EP2023/080561, filed on Nov. 2, 2023, which claims priority to GB Application No. 2218004.6, filed on Nov. 30, 2022, the contents of each of which are hereby incorporated by reference.

### BACKGROUND

### Technical Field

The disclosure relates to a method for disposing and recycling at least one cartridge comprising a cartridge container and a head part.

### Background Information

Cartridges that are configured to store and dispense at least one material are being used in a wide variety of different application fields ranging from the medical sector to the industrial sector. Thus, the amount of cartridges that are circulating is tremendously high.

### SUMMARY

Consequently, as such cartridges are usually formed of some kind of plastic, it has been determined that the amount of plastic being used in their manufacturing process is also extremely high, thereby leading to a high environmental impact.

Furthermore, regardless of the concrete application field of the above cartridges, when filled, they often contain viscous materials that can be irritant or even toxic and that are not supposed to be discarded in the environment.

Because of the above and because of the great amount of application fields, which leads to a high amount of cartridges—and thus plastic—being used, it desirable to find a suitable way to improve the process of disposal and/or recycling of such cartridges.

Conventionally, used cartridges that were originally filled with irritant or toxic viscous materials have to be entirely disposed as hazardous waste. This is done to avoid any of these materials to unwantedly get into the environment.

In case the cartridges were originally filled with harmless materials, it is another option to clean the cartridges with known cleaning techniques and/or cleaning agents such that they can be refilled and thus used again. This option allows a reduction of the amount of plastic circulating in the environment as less new cartridges need to be produced.

However, it is often difficult—if not even impossible—to realize this recycling option when the cartridges were previously filled with the above mentioned materials, for instance, or when the cartridges were filled, for example, with a material that instantly hardens once it gets in contact with air as such hardened materials are not easily removed from a cartridge wall.

In view of the above it is an object of the disclosure to provide a method and system for disposing and recycling cartridges with which the above mentioned drawbacks can be overcome. This object is solved by the disclosure according to the subject matter disclosed herein.

In particular according to a first aspect of the disclosure a method for disposing and recycling at least one cartridge is provided, with the cartridge comprising a cartridge container and a head part. The cartridge is further configured to a store at least one material, preferably a viscous material. The method according to the disclosure comprises the following steps: providing the at least one cartridge and at least one receptacle configured to receive the at least one cartridge; placing the cartridge into the receptacle such that at least an upper part, in particular the head part, of the cartridge extends beyond an upper open edge of the receptacle; and removing the upper part of the cartridge, in particular at least the head part from the cartridge container, at a plane extending along the upper edge of the receptacle.

Thus, according to the disclosure the cartridge is inserted into the receptacle such that at least the upper part, e.g. the head part, of the cartridge extends beyond the upper edge of the receptacle. That is, at least the upper part which is going to be removed in a later step extends beyond the upper edge of the receptacle. This allows a removing instrument, such as a saw or the like, to remove the upper part the upper part from the rest of the cartridge along the upper edge of the receptacle.

It is noted that according to the present disclosure the expression “upper part of the cartridge” relates to the part of the cartridge that is closest to its outlet, respectively its head part. This can also be seen in the Figures.

That is, according to the disclosure the upper part of the cartridge is defined to include at least the head part of the cartridge. However, it can also be possible that it further includes parts of the cartridge container adjacent to the head part such that the cartridge container is basically cut into two pieces when the upper part of the cartridge is removed.

In this connection it is further noted that it could also be possible that the upper edge of the receptacle is used as an alignment means or device for the removing process such that the upper part can be removed along a plane extending at least in parallel to the upper edge, in particular along a plane which is spanned by the upper edge.

According to the disclosure the at least one cartridge that is inserted into the receptacle is either completely empty or has at least been emptied to a certain extent such that the upper part that is removed is the part of the cartridge which is still contaminated with the material previously stored therein. Consequently, the lower part of the cartridge is empty and thus at least essentially free from the material previously stored therein.

After the upper part of the cartridge is removed, the lower part of the cartridge can, for example, remain in the receptacle such that the receptacle can further be used as a transportation container to transport the one or more lower parts of the cartridges to their intended disposal or recycling sites.

The removed upper parts of the one or more cartridges on the other hand can be collected in a separate receptacle or container that can e.g. be used to store and/or transport them.

Hence, with the method according to the disclosure one can easily separate contaminated from non-contaminated, i.e. essentially clean, parts of the cartridge such that the essentially clean parts can be reused or recycled or at least disposed with the conventional garbage while the contaminated parts can be disposed at a special disposal site configured to handle hazardous waste. This way, the amount of hazardous waste can be reduced. At the same time, the amount of plastic that can generally be reused and/or recycled can be increased, thereby contributing to a more sustainable way of handling used cartridges.

According to a first aspect of the disclosure the head part is made of a solid material which is sealingly and fixedly connected to the cartridge container. The head part can for example be made out of a rigid material such as PP, PE, PA, PET, PLA, PHA, PBAT, PCL, recycled materials, bio-based feedstock, fossil-based materials and/or combinations of the foregoing.

In this connection it is further noted that the head part and the cartridge container can be made out of the same material. They can even be formed as one single piece. In other cases, however, it can also be possible that the head part and the cartridge container are made out of different materials such that the two parts are later connected with one another.

According to another embodiment the head part further comprises an outlet through which the at least one material is dispensed. That is, when the cartridge is still filled, the material can be dispensed through the outlet. This can be done for example by using a suitable dispenser or dispensing mechanism. Such dispensers and/or dispensing mechanisms are known state of the art.

According to a further embodiment the cartridge container is made of a solid material such that the container is rigid. As mentioned above, the solid material can either be the same material as the one used for the head part of the cartridge or can also be a different type of material. The suitable material used for the container can for example be chosen depending on the material that is supposed to be stored therein. Possible materials can PP, PE, PA, PET, PLA, PHA, PBAT, PCL, recycled materials, bio-based feedstock, fossil-based materials and/or combinations of the foregoing.

It is further possible that the cartridge comprises a piston configured to urge the material stored inside the cartridge towards the head part and further configured to seal a rear end of the cartridge container. Hence, the rear end of the cartridge container can be provided by the piston which is configured to seal the rear end. By then moving the piston towards the outlet, an inner volume of the cartridge container is reduced such that the material stored therein is urged towards the outlet and thus dispensed. This can for example be done manually or with the use of conventionally known manual, electrical or pneumatic dispensers.

According to an alternative embodiment the cartridge container is made of a flexible material, in particular a film material consisting of one or more layers of material. Such flexible cartridge containers are often used in connection with solid support sleeves into which the flexible cartridge containers are inserted upon use of the cartridge, i.e. when the material stored therein is supposed to be dispensed. In such cases the support sleeve comprises a piston that is configured to be moved towards the head part of the cartridge such that the flexible cartridge container is compressed and the material stored therein is urged out of an outlet, in particular the outlet of the head part.

Such flexible cartridge containers provide a particularly safe and clean dispensing of material as neither the support sleeve nor the piston gets into contact with the material stored therein such that they can be easily reused.

Furthermore, empty flexible cartridges comprise a significantly lower storage volume as they can be compressed such that more cartridges can be inserted into one receptacle and/or transportation box.

Possible materials out of which such flexible cartridge containers can be made of can be chosen from the group of polyethylene, polypropylene, polyamide, polyethylene terephthalate, poly butylene terephthalate, and/or combinations of the foregoing.

Regardless of whether the cartridge container is made out of a rigid or a flexible material the cartridge can further be one of a 1K and 2K cartridge. That is, the cartridge can either comprise one single cartridge container or two cartridge containers with each container being configured to store at least one material, wherein in particular the materials differ from one another.

In this connection it is noted that in the case of a 2K cartridge the two cartridge containers can be arranged coaxially or next to one another, i.e. side by side.

Furthermore, in the case of a 2K cartridge, the head part of the two cartridge containers can consist of two separate head part elements, i.e. one head part element for each container. The head part elements can for example be connected with one another to form a common head part. Furthermore, it is either possible that each head part element comprises a separate outlet through which the materials stored inside the containers can be dispensed, or that the two head part elements comprise a common outlet when they are connected with one another such that the materials stored in the two cartridge containers are mixed upon dispensing.

The one or more head part elements can further be configured to be attached to a mixer that is configured to mix the two materials from the two cartridge containers. Many kinds of static or dynamic mixers are known and are thus not described here in detail.

According to an alternative embodiment the head part of the two cartridge containers is a common head part for both cartridge containers with the common head part in particular comprising one or more outlets. Also in this case the head part can further be configured to be connected to a mixer.

According to another embodiment of the disclosure the cartridge container comprises at least one predetermined separation section at which the upper part of the cartridge is removed during the step of removing the upper part of the cartridge. The predetermined separation section can allow for an easier separation of the upper part from the cartridge container comprising a lower wall thickness or a punched separation line at the separation section, for example. Other mechanical features are conceivable that can act as separation sections.

In other cases the predetermined separation section can also only be a visual mark that indicates a user or a removing instrument where to exactly remove the upper part of the cartridge. The visual mark can also be provided in addition to the above mentioned mechanical separation section, e.g. to indicate its position.

The separation section can further be arranged between the upper edge of the receptacle and a rear end of the piston, when the cartridge is placed in the prescribed manner in the receptacle and the rear end of the piston is at a position above the upper edge of the receptacle. This way, the upper part of the cartridge can be removed behind the rear end of the piston such that the piston seals the rear end of the removed upper part which can still contain material which has not yet been dispensed. Furthermore, by removing the upper part right behind the piston, regardless of where exactly along a longitudinal length of the cartridge container the piston is arranged, it is not important whether the cartridge has been emptied completely or not prior to removing the upper part as the piston not only seals the rear end of the cartridge but also the rear end of the removed upper part.

This is also advantageous as the piston usually is also contaminated with the material such that it needs to be disposed separately, in particular together with the head part.

According to another embodiment the piston and the cartridge container comprise corresponding breaking features that allow the upper part of the cartridge to be removed when the breaking features of the piston and the breaking features of the cartridge container align with one another, with the breaking features in particular marking the predetermined separation section of the cartridge. That is, according to this embodiment the piston as well as the cartridge container can comprise breaking features that match with one another functionally, when the piston is at a predetermined position relative to the cartridge container, i.e. when the breaking features of the piston reach the breaking features of the cartridge container. The breaking features can be configured such that the removing of the upper part of the cartridge is facilitated by the breaking features inducing the removal.

According to a further embodiment it is also possible that only the cartridge container comprises breaking features which can, for example, be actuated by a user or which can be actuated by a dispenser (e.g. automatically).

In this connection it is noted that the breaking features can comprise matching or complementary protrusions (e.g. bladelike protrusions), pins, holes, recesses and/or combinations of the foregoing which can induce the step of removing the upper part. As only one example, the piston can comprise one or pins that correspond with one or more holes of the cartridge container respectively, or vice versa. Thus, it can be seen that a great variety of different matching breaking features is possible such that it can be chosen freely which option is preferred.

According to a further embodiment of the disclosure the receptacle is configured to receive more than one cartridge. That is, the receptacle can be configured to receive two or more cartridges at the same time such that the whole disposing and recycling process can be optimized time wise.

According to another embodiment the receptacle comprises a substantially round, oval, rectangular, square or polygonal inner and/or outer shape. The shape of the receptacle can for example be adapted to the shape of the cartridge(s) that is(are) supposed to be inserted into the receptacle, so as to facilitate a space-optimized storage of the cartridge(s).

According to another embodiment the receptacle comprises an inner reception space configured to receive the at least one cartridge, with the reception space comprising a minimum height dependent from a longitudinal length of the cartridge. That is, the minimum height of the reception space can for example be chosen such that the upper part, in particular at least the head part, that is supposed to be removed from the cartridge, extends beyond the upper edge of the receptacle.

According to yet another embodiment the minimum height lies in the range of 50 to 99%, preferably, 60 to 90%, in particular 75 to 85%, of the longitudinal length of the cartridge container. Usually a greater part of the cartridge container is received within the reception space of the receptacle such that only a short length of the cartridge extends beyond the upper edge. The reason for this is that it can be preferred to only dispose completely empty cartridges such that only a small part of the cartridge needs to be removed and disposed while the rest of the cartridge can be recycled.

According to a further embodiment of the disclosure the step of removing at least the upper part includes cutting, breaking, laser cutting, shearing, sawing and/or combinations of the foregoing. The exact way of removing the upper part can be chosen in accordance with the material out of which the cartridge container is made as some materials might be broken easily while others need to be cut to ensure a safe removal of the upper part. The upper edge of the receptacle can serve as a guide means or element for the chosen removal tool.

According to another embodiment the method further comprises the step of providing at least one receiving section at a bottom surface of the receptacle between the bottom surface and the cartridge, in particular with the receiving section being configured to adjust a height between a rear end of the cartridge and the bottom surface of the receptacle. The receiving section can further be configured to secure the cartridge while the upper part is being removed such that the cartridge does not move or tilt during the method step.

Furthermore, it can also be possible that the receiving section is configured to adjust a height between the rear end of the cartridge and the bottom surface of the receptacle. This can be particularly advantageous when for example half-empty cartridges are supposed to be disposed/recycled with the method according to the disclosure or when a plurality of different types of cartridges are being processed that can comprise different longitudinal lengths and/or which may not all be completely empty.

By providing a receiving section that is configured to adjust the height between the rear end of the cartridge and the bottom surface of the receptacle it can be ensured that only the upper part that is supposed to be removed extends beyond the upper edge of the receptacle.

In this connection it is also noted that the receiving section can further comprise a cross section that matches an inner and/or outer transversal cross section of the cartridge container. This way, the receiving section can be used as coding means or device such that only cartridges of a certain type and/or shape can be received by the receiving section which can be useful when, for example, cartridges that previously contained hazardous or toxic substances are supposed to be processed as parts that are still contaminated with the materials need to be disposed separately. The receiving section can act as the storing portion mentioned above.

According to a further embodiment, the receiving section can be configured to hold and/or compress the flexible cartridge container such that the head part extends beyond the upper edge of the receptacle. This can be advantageous since a flexible cartridge container alone cannot easily provide for a stable fixation of the cartridge inside the receptacle.

According to another embodiment the receiving section is a separate element, preferably a separate element that can be releasably fixed at the bottom surface of the receptacle by a click-, bayonet-and/or form fitting-connection. A releasable receiving element can provide a higher flexibility as the receptacle can be configured to receive different types of cartridges having different heights and/or shapes since a user can choose which receiving element needs to be inserted into the receptacle prior to inserting the respective cartridges. The receiving section can also be adjustable, e.g. as regards its vertical extension.

Alternatively, one can also think of the receiving section being an integral part of the receptacle or a separate part that is fixedly connected to the bottom surface of the receptacle.

According to a further embodiment the method comprises the step of providing an alignment element in the receptacle prior or after the step of placing the at least one cartridge into the receptacle, with the alignment element being configured to hold the cartridge in an upright position. Such an alignment element can either be placed inside the receptacle or it can also be configured to be placed on top of the receptacle, i.e. on the upper edge of the receptacle, as a lid. Either way the alignment element is configured to align the one or more cartridges such that their upper ends, i.e. the upper part including the head part, always extends beyond the upper edge of the receptacle. This can be especially crucial during the step of removing the upper part of the receptacle as shear forces can act on the upper part of the cartridge while it is being removed which can lead to the cartridge tilting or even falling over.

In this connection it should also be noted that the alignment element can be configured as a template comprising at least one opening through which the cartridge extends. Hence, the alignment element can comprise one or more openings that match the respective shape of the cartridge(s) such that the alignment element can easily hold the one or more cartridges in place.

It may further be possible that the alignment element and the cartridge comprise corresponding coding features that match with one another. This way only certain cartridges can be held with a designated alignment element thereby providing a coding possibility that allows a user to collect only predetermined cartridges in a certain receptacle. This can for example be advantageous in case one would want to only collect cartridges that had previously been filled with one certain type of material.

Such coding features can comprise matching protrusions, recesses, pins, holes, labels, tags, in particular RFID tags, captions, color coding and/or combinations of the foregoing which easily allow the identification of the right cartridge respectively the right alignment element.

According to a further embodiment of the disclosure the receptacle comprises additional keying features that allow only a certain type of cartridges, head parts and/or containers to be received in the receptacle. As already mentioned above in connection with the alignment element, this can in particular be advantageous in case one would want to only collect cartridges that had previously been filled with one certain type of material. Another option would be if only certain cartridges comprising a certain shape should be collected.

Such keying features can for example be chosen from the group consisting of color codes, labels, templates, tags, in particular RFID tags, captions, protrusions, recesses, pins, holes and/or combinations of the foregoing to allow an easy identification of the right cartridges, head part and/or containers, respectively.

According to another embodiment the method further comprises the step of covering the receptacle with a cover element prior and/or after the upper part of the cartridge has been removed. By providing a cover element that covers the receptacle after the upper part of the cartridge has been removed the receptacle that is filled with one or more cartridge containers can easily be transported to its designated disposal/recycling site. Additionally or alternatively it can be useful to already cover the receptacle with a cover element prior to removing the upper parts of the cartridges assembled in the receptacle for storage and/or transportation reasons, for instance.

Furthermore, it could also be possible to provide the cover element prior to removing the upper part of the cartridge that can for example be used to hold the cartridge in place and/or to facilitate the removal of the upper part by providing a guide along which the upper part is being removed.

In this connection it should also be noted that the cover element can further be configured to close the receptacle by extending beyond the upper edge towards a bottom of the receptacle such that it forms a lid.

According to a further embodiment the cover element comprises at least one holding element configured to engage with the head part to hold the head part in place when the receptacle is closed with the cover element. Such a holding element can for example comprise a shape that corresponds with the shape of the head part such that the head part can slide into the holding element when the cover element is placed on the receptacle.

Alternatively, it could also be possible that the holding element is configured as a snap connection that fixes the head part when the cover element is placed on the receptacle. Further holding and/or fixing means devices are also possible and can be chosen freely.

According to a further embodiment the holding element can also be configured to bias the cartridge against a bottom of the receptacle. This way, the cartridge is fixedly secured, especially for the step of removing the upper part of the cartridge and/or for transportation of the receptacle to its designated disposing/recycling site.

Further, it can also be possible that the holding element is configured to align the cover with the upper edge of the receptacle. This can for example be advantageous when several cartridges are placed in the receptacle that comprise a difference in height. Hence, the holding element can also be configured to compensate a difference in height.

According to a further embodiment the method additionally comprises the step of providing at least one collection box configured to store the upper part of the cartridge, such as the head part, or a remaining lower part of the cartridge, such as the cartridge container, after removing the upper part from the cartridge such that each part, i.e. the upper and the lower part, can be stored and thus disposed or recycled separately.

In this connection it should be noted that the collection box can comprise coding features that allow only a certain type of upper parts or lower parts to be received within the box. This can be necessary when, for example, hazardous or toxic substances have been previously stored in the cartridges that need to be disposed separately.

Furthermore, it can be possible that the coding features are chosen from the group consisting of color codes, labels, templates, tags, in particular RFID tags, captions, protrusions, recesses, pins, holes and/or combinations of the foregoing that easily allow the identification of the predetermined upper and/or lower parts.

According to a second aspect of the disclosure a disposing and recycling system is provided which is configured to dispose and recycle a cartridge that is configured to store and dispense at least one material, in particular a fluid. The system comprises at least one cartridge having a cartridge container and a head part, with the container and the head part being sealingly connected to one another. Furthermore, the system comprises a receptacle configured to receive and store the at least one cartridge such that an upper part, in particular the head part, of the cartridge extends beyond an upper edge of the receptacle. The components of the system can in particular be configured to carry out the method according to any of the preceding claims.

Such a system can provide a particularly easy and effective way of disposing and/or recycling used, i.e. (half-) empty, cartridges as the receptacle is configured to effectively collect such cartridges by receiving them such that the upper part of the cartridge, in particular the head part, extends beyond the upper edge of the receptacle. This allows a neat collection of the one or more cartridges inside the receptacle such that further processing of the cartridges is made a lot easier.

According to an embodiment of the disclosure the cartridge container comprises a predetermined separation section at which the upper part of the cartridge is removed, in particular cut, broke, laser cut, sheared, sawed and/or removed by combinations of the foregoing. The predetermined separation section can for example allow an easier separation of the upper part from the cartridge container by comprising a smaller wall thickness or a punched separation line at the separation section.

In other cases the predetermined separation section can also be or comprise a visual mark that shows a user or a removing instrument where to exactly remove the upper part of the cartridge.

According to a further embodiment the cartridge container is one of a flexible and a solid cartridge container, with the solid cartridge container in particular comprising a piston configured to seal a rear end of the container and further configured to urge material stored inside the cartridge towards the head part.

According to yet another embodiment the receptacle further comprises at least one receiving section at a bottom surface of the receptacle configured to receive the cartridge, in particular with the receiving section being further configured to adjust a height between a rear end of the cartridge and the bottom surface of the receptacle. The receiving section can for example be configured to secure the cartridge while the upper part is being removed such that the cartridge does not move or tilt when stored inside the receptacle.

Furthermore, it can also be possible that the receiving section is configured to adjust a height between the rear end of the cartridge and the bottom surface of the receptacle. This can be particularly advantageous when for example half-empty cartridges are supposed to be disposed/recycled with the method according to the disclosure or when a plurality of different types of cartridges are being assembled in the receptacle that can comprise different longitudinal lengths and/or which can not all be completely empty.

By providing a receiving section that is configured to adjust the height between the rear end of the cartridge and the bottom surface of the receptacle it can be ensured that only the upper part extends beyond the upper edge of the receptacle.

### BRIEF DESCRIPTION OF THE DRAWINGS

The disclosure is further described with the following embodiments which are presented in the Figures. The Figures show:

FIG. 1 is an exemplary scheme of the method according to the disclosure;

FIG. 2 is a receptacle including a receiving space with a receiving element;

FIG. 3 is a cross section of an upper part and a receiving element;

FIG. 4 is an embodiment of a disposing and recycling system according to the disclosure;

FIG. 5 is another embodiment of the disposing and recycling system according to the disclosure;

FIG. 6 is an embodiment of the method using the system of FIGS. 4 and 5;

FIG. 7. an cross section of a receptacle including an alignment element and a top view of the alignment element including coding features;

FIG. 8 are top views of cartridges comprising coding features;

FIG. 9 is another example of an alignment element including coding features;

FIG. 10 is a cross section of a cartridge container and a piston including matching breaking features; and

FIG. 11 are further examples of cartridge containers including breaking features; and

### DETAILED DESCRIPTION

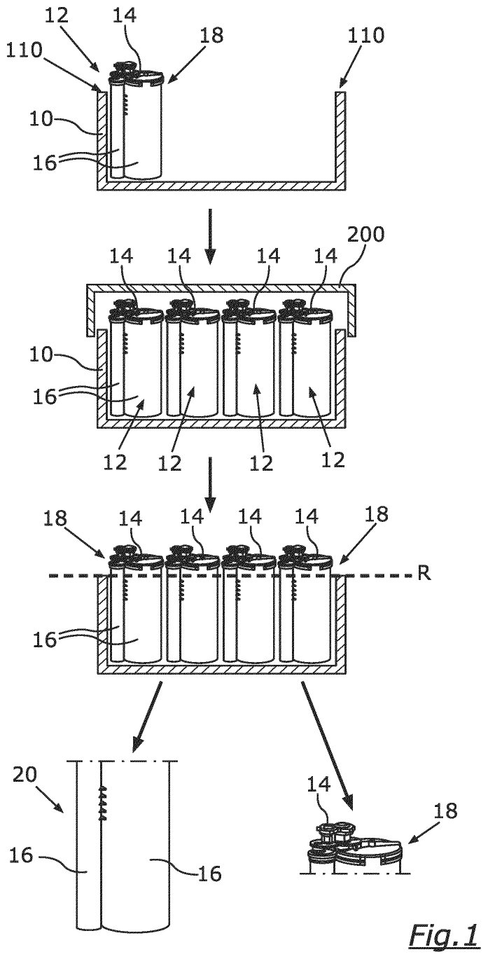

FIG. 1 shows an exemplary scheme of the method as well as a system according to the disclosure. A receptacle 10 (hereinafter simply denoted as box) is provided into which a used cartridge 12 is placed. Obviously, it is possible to insert as many cartridges 12 into box 10 as the box 10 can hold.

In some cases, box 10 can comprise keying features to determine what kind of cartridges 12 are supposed to be collected within the box. Such keying features can comprise color codes, labels, templates, tags, in particular RFID tags, captions, protrusions, recesses, pins, holes and/or combinations of the foregoing (not shown).

The cartridges 12 are inserted such that a head part 14 of the cartridge 12 extends beyond the upper edge 110 of box 10. In the embodiment shown in FIG. 1 not only the head part 14 extends beyond the upper edge 110 but also parts of a cartridge container 16 of each cartridge 12 which is connected to the head part 14. In the embodiments shown in the Figures the cartridges 12 always comprise two cartridge containers 16 that are arranged next to one another. However, it is e.g. also possible for the cartridge 12 to only comprise one cartridge container 16 or two cartridge containers 16 that are arranged coaxially.

In this connection it should be noted that the cartridge container 16 can be one of a solid or a flexible cartridge container 16.

Optionally, and as also shown in FIG. 1, it is possible to place a cover 200 on the box 10 to close the box 10 for transportation of the box 10 to the intended recycling/disposing site before or after removal (the latter is not shown in FIG. 1) of head part 14.

At the recycling/disposing site the cover 200 is removed and the upper parts 18 of the cartridges 12 that are arranged in the box 10 are removed by, for example, cutting them along the upper edge 110 of box 10, which is depicted as a dashed line R in FIG. 1.

This way, the cartridges 12 that are arranged inside the box 10 get divided into two parts, the upper part 18 and a remaining lower part 20. The lower part 20 can for example remain in the box 10 while the upper part 18 can be collected in a separate collection box/container (not shown).

By dividing the cartridges 12 into two pieces, it can be ensured that the upper part 18, which often still contains remains of the material that had previously been stored inside the cartridge 12 (often not recyclable), can be disposed independently from the lower part 20 that is often at least almost clean such that the lower part 20 can be recycled to reduce the amount of plastic waste circulating in the environment.

In this connection it should be noted that the optional cover 200, which was previously used for transportation of the filled box 10, can be reused again once the upper parts 18 of the cartridges 12 have been removed, to close box 10 for transportation of the remaining lower parts 20 to their respective recycling/disposing site (not shown). Alternatively, it could also be possible to use another, separate, cover 200 to close box 10 for transportation of the lower parts 20.

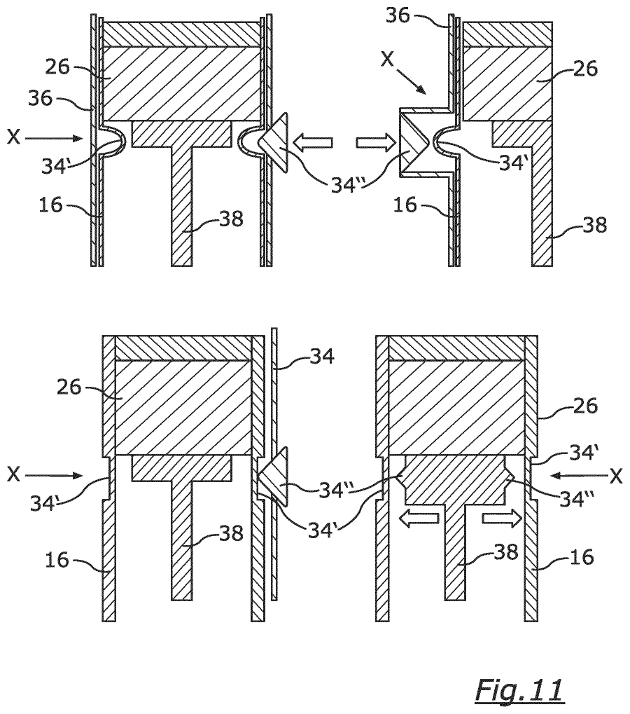

In order to facilitate the removal of the upper parts 18 from the lower parts 20, the cartridge containers 16 can comprise a separation section X (see e.g. FIG. 10 or 11) at which the removal of the upper part 18 is supposed to take place. The cartridge container 16 can, for example, comprise a (locally) smaller wall thickness at the separation section X to allow an easier removal of the upper part 18. Additionally or alternatively, one could also think of a punched and thus weakened line as separation section X at which a cutting knife or saw can easily cut through the walls of the cartridge container 16.

Further possibilities to allow an easier removal of the upper part 18 by providing breaking features 34′, 34″ are shown in FIGS. 10 and 11.

FIG. 10 shows two exemplary embodiments of the separation section X as well as the breaking features 34′, 34″ (geometrically exaggerated).

The embodiment shown on the left hand side of FIG. 10 shows a cross section of a cartridge container 16 which comprises a piston 26 which has not yet arrived at the position of the separation section X. The separation section X of the cartridge container is configured such that it comprises a breaking feature 34′ in the form of a recess 34′ which protrudes into an interior of the cartridge container 16.

When the piston 26 reaches the position of the protrusion 34′ a higher force is needed to keep the piston 26 moving towards the head part 14 such that the recess 34′ is pushed radially outwards, thereby weakening the cartridge container 16 such that a predetermined separation section X in the form of a predetermined breaking point is created.

The right hand side of FIG. 10 shows an embodiment where both the piston 26 and the cartridge container 16 comprise breaking features 34′, 24″. In this case breaking feature 34′ of the cartridge container 16 is defined by the cartridge container 16 comprising a thinner wall thickness at the separation section X. The breaking feature 34″ of the piston 26 is defined by the piston 26 comprising a ring-shaped protrusion 34″ which is configured to break the through the wall of the cartridge container 16 at the separation section 16 once it reaches the position.

Alternatively, in both of the above embodiments it can be possible that the breaking features 34′, 34″′ of the cartridge container 16 as well as the piston 26 are only configured to provide a haptic feedback to the user when dispensing the contents of the cartridge 12 such that they know that the cartridge 12 is now ready to be discarded.

Another embodiment for exemplary breaking features is shown in the upper part of FIG. 11. In this case the breaking features 34′ of the cartridge container 16 are generally the same as in the above described embodiment of the left hand side of FIG. 10. However, the right hand side of FIG. 11 shows a breaking feature 34′ in the form of a protrusion instead of a recess.

Furthermore, according to this embodiment the dispenser with which the cartridge 12 is emptied, comprises a support sleeve 36 into which the cartridge 12 is inserted and which comprises breaking features 34″ that are complementary to the breaking features 34′ of the cartridge container 16.

As one can see, in this case, it is possible to break the cartridge container 16 into two pieces, i.e. the upper part 18 and the lower part 20, by moving the breaking features 34″ of the support sleeve 36 towards the recess/protrusion 34′ of the cartridge container 16 until the container wall gives in and breaks.

The same concept is also shown on the lower left hand side of FIG. 11 where the only difference is that the breaking feature 34′ of the cartridge container 16 is given by a smaller wall thickness at the separation section X.

According to the lower right hand side of FIG. 11 however, not a support sleeve 6 comprises the matching breaking features 34″ to the breaking feature 34′ of the cartridge container 16 (i.e. the smaller wall thickness), but a front end of a piston rod 38 which is configured to move the piston 26 towards the head part 14 of the cartridge 12.

The front end of the piston rod 38 can be configured such that its breaking features 34″ break through the thinner wall 34′ once it reaches the separation section X thereby breaking the cartridge 12 into the upper part 18 and the lower part 20.

Obviously, the above mentioned embodiments are only of exemplary nature and the disclosure is not limited to the these examples.

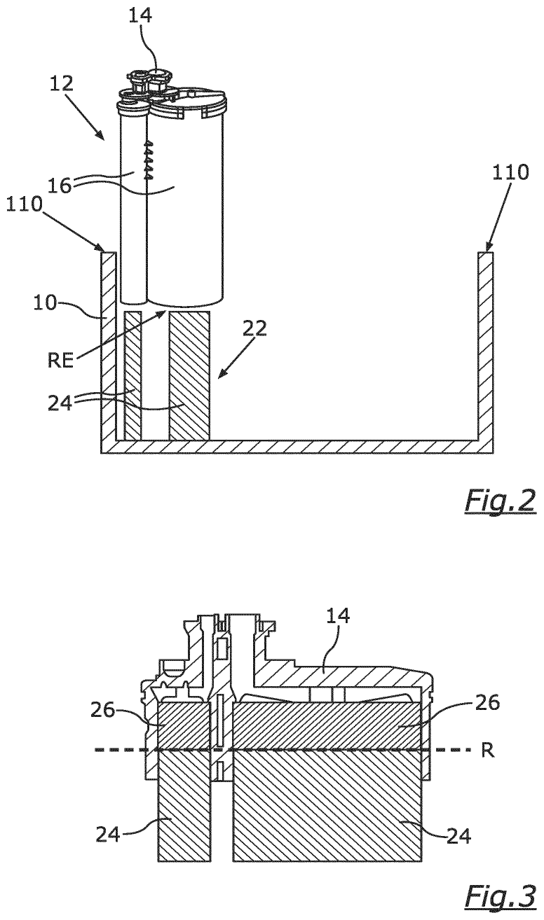

FIG. 2 shows that box 10 can further comprise a receiving space 22 that is configured to receive the cartridge 12. The receiving space 22 can be designed such that it is configured to fix the cartridge 12 in place, especially during the step of removing the upper part 18 of the cartridge 12.

One option for such a receiving space 22 is shown in FIGS. 2 and 3 where the receiving space 22 is formed by receiving element 24 (in this case two bars or rods 24) that can be inserted into the cartridge containers 16 from a rear end RE of the cartridge 12 until they get in touch with a piston 26 which is usually arranged inside the cartridge containers 16 (see FIG. 3).

This way, the receiving element(s) 24 can easily hold the cartridge 12 in place such that its/their upper part 18 extends beyond the upper edge 110 of box 10. In some cases it can even be possible that the receiving element 24 is adapted to the type of cartridge 12 which is being collected, for example by having a suitable length and/or transversal cross section, such that an appropriate positioning of the cartridge 12 within the box 10 can be ensured.

In this connection it is noted that the receiving element 24 can e.g. be configured as a separate element which can be inserted in and releasably connected to the box 10 when needed, or it can also be formed integrally with the box 10 such that the box 10 itself already comprises one or more receiving spaces 22 respectively receiving elements 24.

In some embodiments the position at which the receiving element 24 touches the piston 26 defines the rear end of the upper part 18. In such a case, the cartridge container 16 is, for example, cut right between the front end of the receiving element 24 (i.e. the upper end in the Figures) and the rear end of the piston 26 (i.e. the lower end in the Figures), as it is depicted by removal line R in FIG. 3.

Furthermore, it can be possible that the receiving space 22, respectively the receiving element 24 comprises a cross section that matches the cross section of the cartridge 12, respectively the cartridge container 16, that is supposed to be processed to enable a form of coding. This way, only a certain type of cartridge 12 can be collected within a predetermined box 10 as other types of cartridges 12 will not fit within the coded receiving space 22.

Another option to provide coding can be certain coding elements such as pins, protrusions or the like or even RFID chips etc. which allow a recognition of the collected cartridge 12 as well as the used box 10 to determine which cartridge 12 needs to be collected within which specific box 10.

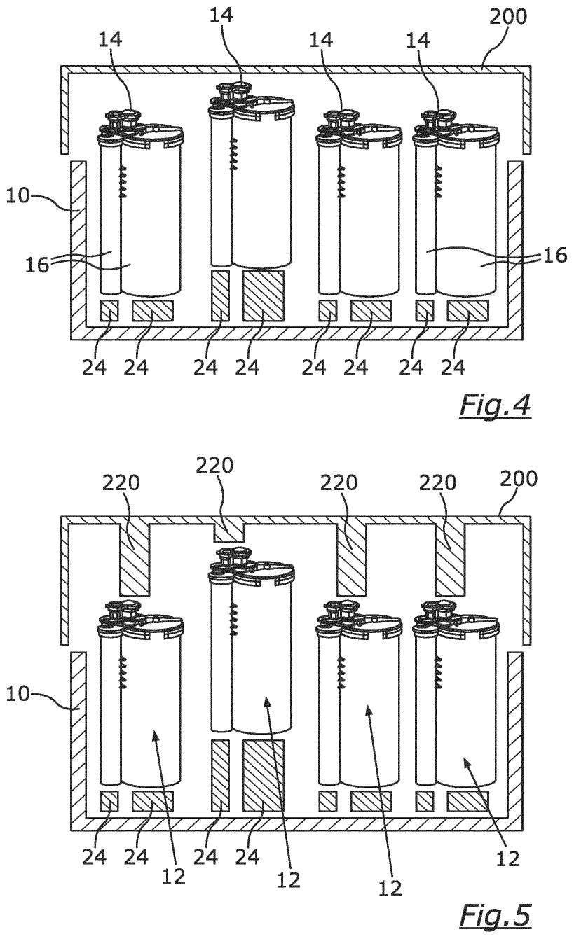

Furthermore, as can be seen in FIG. 3, for instance, the receiving element(s) 24 can also be used to make sure that the lower end of the upper part 18 is always defined by the lower end of the piston 26 such that when a cartridge 12 is not completely empty, it will extend further beyond the upper edge 110 compared to empty cartridges 12 (see FIG. 4). This ensures that the piston 26 can seal the lower end of the upper part 18 such that no material leaks out of the upper part 18 and thus contaminates to lower part 20 as well as the box 10 and/or possibly the other cartridges 12.

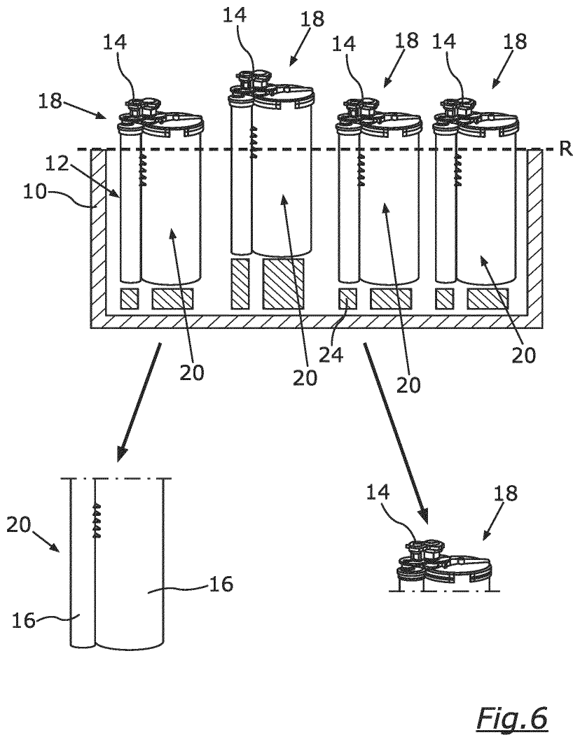

The step of removing the upper ends 18 of the cartridges 12, where one cartridge 12 is not completely empty is also shown in FIG. 6. In this Figure it can also be seen that the half-empty cartridge 12 extends beyond the head parts 14 of the other cartridges 12 such that it will be divided at a different position of its cartridge containers 16 than the other cartridges 12.

Hence, the receiving element 24 can not only be configured to hold the cartridge 12 in place. Furthermore, as mentioned above, it can be configured such that one can easily determine whether a cartridge 12 has been fully emptied or not. Additionally, it is possible that the receiving element 24, respectively the receiving space 22, provides a coding means or device that only allow cartridges 12 of a certain type and/or shape to be collected within a predetermined box 10.

In case at least one of the collected cartridges 12 is not completely empty, it can be difficult to provide a cover 200 that is still able to close the box 10 for transportation purposes. For this reason, it can be possible for the cover 200 to comprise holding elements 220 that are configured to hold every cartridge 12 in place even though their upper ends, i.e. their head parts 14 do not align in a common horizontal plane. Such holding elements 220 are schematically shown in FIG. 5 where it can be clearly seen that the one cartridge 12 that extends beyond the other cartridges 12 is matched with a holding element 220 that is adapted such that the cover 200 is aligned horizontally to sealingly close box 10 for transportation such that the cartridges 12 are reliably held the box 10.

The holding elements 220 can be designed in many different ways. They can, for example, comprise snap connections that are configured to fix the head parts 14 of the cartridges 12 to the cover 200. Additionally or alternatively they can also comprise a cross section that is adapted to the respective head part 14 which is supposed to be fixed by the holding element 220. In some cases it can also be possible for the holding elements 220 to bias the cartridges 12 against the bottom surface of box 10 to better fix the cartridges 12 in place.

Furthermore, the holding elements 220 can be configured as separate elements that can be attached to an inner surface of the cover 200. Alternatively, the cover 200 and the holding elements 220 could also be formed integrally.

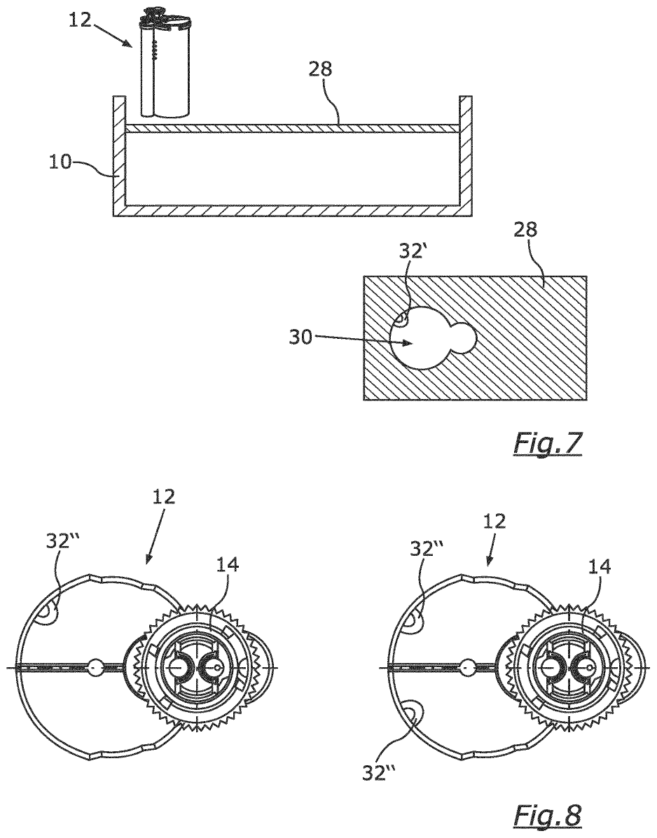

Another option to hold the cartridges 12 safely inside the box 10 is to provide an alignment element 28 that is configured to hold and fix the cartridges 12 in place inside the box 10. One example of such an alignment element 28 is shown in FIG. 7 where the alignment element 28 is provided in the form of a template with openings 30 that correspond to the cross sections of the cartridges 12 that are supposed to be held by the alignment element 28.

As one can see in FIG. 7, the alignment element 28 can, for example, cover the complete interior of the box 10 just like a cover 200 would. Nevertheless, it could also be possible that the size of one alignment element 28 is adapted to the size of each individual receiving space 22 within the box 10 such that each cartridge 12 comprises its own alignment element 28.

In this connection it should further be noted that according to one embodiment the alignment element 28 can be provided as one or more separate elements that are inserted in a box 10 when needed. Alternatively, it could also be possible that the one or more alignment elements 28 are formed integrally with the box 10.

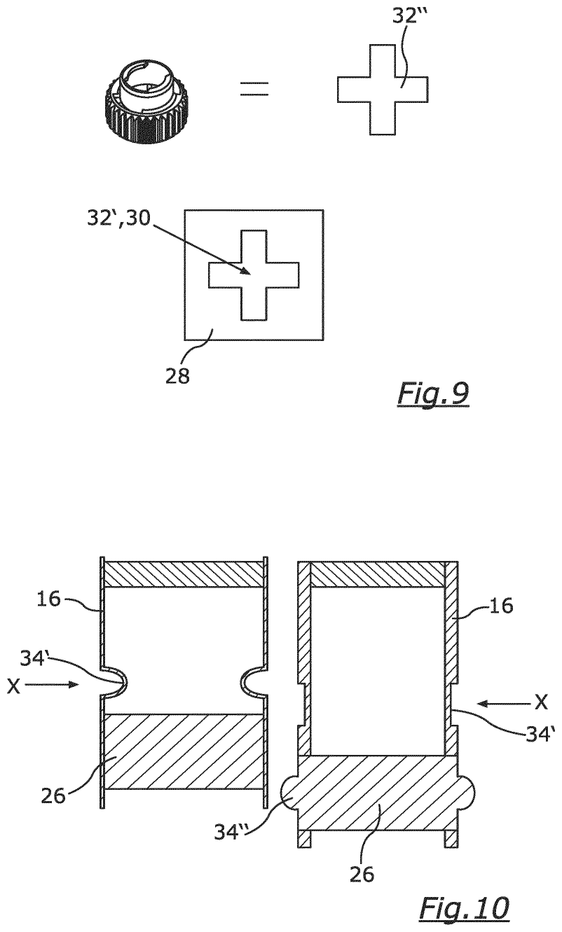

It can further be seen that by providing an alignment element 28 that comprises one or more openings 30 with shapes that correspond to the cross sections of the respective cartridges 12 that are supposed to be held with the alignment element 28, a further type of coding can be ensured as only certainly sized and shaped cartridges 12 or single components of a cartridge 12 can be inserted into the openings 30 of the alignment element 28 (see FIG. 9) and thus also into box 10 or a further collection box.

Another option to ensure a clear determination of the cartridges 12 and/or components that are supposed to be collected can be to provide additional coding features 32′, 32″ which are schematically shown in FIGS. 7 and 8 at the opening 30 and the cartridges 12, respectively. As can be seen, both the cartridge 12 and the alignment element 28 comprise coding features 32′, 32″ that correspond with one another such that only such cartridges 12 which comprise the right coding features 32″ can be inserted into a predetermined box 10.

This can be particularly advantageous in case several cartridges 12, which were previously filled with different materials, are identical from the outside such that one cannot see easily determine which cartridge 12 contained which product.

In the case of FIGS. 7 and 8 the left cartridge 12 of FIG. 8 could be inserted in the template 28 of FIG. 7. If the template 28 would be provided with two coding features 32′ only the cartridge 12 depicted on the right hand side of FIG. 8 comprising two complementary coding features 32″ could be stored in box 10. It should be understood that the design of the coding features 32′, 32″ on the template 28 and the cartridge 12, respectively, can be such that only a very specific type of cartridge 12 or group of types of cartridges 12 can be stored in box 10. In the present example both cartridges 12 of FIG. 8 form a group of type of cartridges 12 that can be inserted in opening 30.

By looking at FIG. 9 it can also be seen that the shape of the opening 30 of the alignment element 28 itself can also be designed as a coding feature 32′ by having a shape that only matches with one single component of a cartridge 12 such that only the special component can be inserted in the box 10.

Other options for such coding features 32′, 32″ could be matching protrusions, recesses, pins, holes, labels, tags, in particular RFID tags, captions, color coding and/or combinations of the foregoing.

Hence, it can be seen that with the system and the method according to the disclosure an especially efficient and safe way of disposing and recycling cartridges can be provided which not only leads to a safer way of disposing hazardous waste but which can also lead to the reduction of plastic circulating in the environment as great parts of the used cartridges can be saved and thus recycled.

1. A method for disposing and recycling a cartridge comprising a cartridge container and a head part, the cartridge further being configured to a store at least one material, with the method comprising:
providing the cartridge and a receptacle configured to receive the cartridge;
placing the cartridge into the receptacle such that an upper part of the cartridge extends beyond an upper open edge of the receptacle; and
removing the upper part of the cartridge from the cartridge container, at a plane extending along the upper edge of the receptacle.

2. The method according to claim 1,
wherein the upper part includes a head part that is made of a solid material and is sealingly and fixedly connected to the cartridge container.

3. The method according to claim 1,
wherein the upper part includes a head part that comprises an outlet through which the at least one material is dispensed.

4. The method according to claim 1,
wherein the cartridge container is made of a solid material.

5. The method according to claim 1,
wherein the cartridge further comprises a piston configured to urge the at least one material stored inside the cartridge towards the upper part and further configured to seal a rear end of the cartridge container.

6. The method according to claim 1,
wherein the cartridge container is made of a flexible material including one or more layers of material.

7. The method according to claim 1,
wherein the cartridge is one of a 1K and 2K cartridge.

8. The method according to claim 1,
wherein the cartridge is a 2K cartridge, and comprises two cartridge containers that are arranged coaxially or next to one another.

9. The method according to claim 8,
wherein the upper part includes a head part which includes two separate head part elements.

10. The method according to claim 8,
wherein the upper part includes a head part of that is a common head part for the two cartridge containers.

11. The method according to claim 5,
wherein the cartridge container comprises a predetermined separation section at which the upper part of the cartridge is removed during the removing the upper part of the cartridge.

12. The method according to claim 11,
wherein the predetermined separation section is arranged between the upper edge of the receptacle and a rear end of the piston, when the cartridge is placed in a prescribed manner in the receptacle and the rear end of the piston is at a position above the upper edge of the receptacle.

13. The method according to claim 5,
wherein the piston and the cartridge container comprise corresponding breaking features that enable the upper part of the cartridge to be removed when the breaking features of the piston and the breaking features of the cartridge container align, with the breaking features marking a predetermined removing section of the cartridge.

14. The method according to claim 13,
wherein the breaking features of the piston and the cartridge container comprise matching protrusions, pins, holes, recesses or combinations thereof.

15. The method according to claim 1,
wherein the receptacle is configured to receive more than one cartridge.

16. The method according to claim 1,
wherein the receptacle comprises a substantially round, oval, rectangular, square or polygonal inner or outer shape.

17. The method according to claim 1,
wherein the receptacle comprises an inner reception space configured to receive the cartridge, with the reception space comprising a minimum height dependent from a longitudinal length of the cartridge.

18. The method according to claim 17,
wherein the minimum height lies in the range of 50 to 99% of the longitudinal length of the cartridge container.

19. The method according to claim 1,
wherein the removing the upper part includes cutting, breaking, laser cutting, shearing, sawing or combinations thereof.

20. The method according to claim 1,
further comprising providing receiving a section at a bottom surface of the receptacle between the bottom surface and the cartridge, the receiving section being configured to adjust a height between a rear end of the cartridge and the bottom surface of the receptacle.

21. The method according to claim 20,
wherein the receiving section comprises a cross section that corresponds to an inner or outer transversal cross section of the cartridge container.

22. The method according to claim 6,
wherein the cartridge container is made of a flexible material and the receiving section is configured to hold or compress the flexible material such that the upper part extends beyond the upper edge of the receptacle.

23. The method according to claim 20,
wherein the receiving section is a separate element configured to be releasably fixed at the bottom surface of the receptacle by a click-, bayonet- or form fitting-connection.

24. The method according to claim 1,
further comprising providing an alignment element in the receptacle prior or after the placing the cartridge into the receptacle, with the alignment element being configured to hold the cartridge in an upright position.

25. The method according to claim 24,
wherein with the alignment element is a template comprising at least one opening through which the cartridge extends.

26. The method according to claim 24,
wherein the alignment element and the cartridge comprise corresponding coding features that match with one another.

27. The method according to claim 26,
wherein the coding features of the alignment element and the cartridge comprise matching protrusions, recesses, pins, holes, labels, tags, RFID tags, captions, color coding or combinations thereof.

28. The method according to claim 1,
wherein the receptacle comprises additional keying features that enable only certain type of cartridges, upper parts or containers to be received in the receptacle.

29. The method according to claim 28,
wherein the keying features are from the group consisting of color codes, labels, templates, tags, RFID tags, captions, protrusions, recesses, pins, holes or combinations of thereof.

30. The method according to claim 1,
further comprising covering the receptacle with a cover element prior or after the upper part of the cartridge has been removed.

31. The method according to claim 30,
wherein the cover element is configured to close the receptacle by extending beyond the upper edge towards a bottom of the receptacle.

32. The method according to claim 30,
wherein the cover element comprises a holding element configured to engage with the upper part to hold the upper part in place when the receptacle is closed with the cover.

33. The method according to claim 32,
wherein the holding element is further configured to bias the cartridge against a bottom of the receptacle.

34. The method according to claim 32,
wherein the holding element is configured to align the cover with the upper edge of the receptacle.

35. The method according to claim 1,
further comprising providing a collection box configured to store the upper part of the cartridge or a remaining lower part of the cartridge after removing the upper part from the cartridge.

36. The method according to claim 35,
wherein the collection box comprises coding features that enable only certain type of upper parts or lower parts to be received in the box.

37. The method according to claim 36,
wherein the coding features are from the group consisting of color codes, labels, templates, tags, RFID tags, captions, protrusions, recesses, pins, holes or combinations thereof.

38. A disposing and recycling system configured to dispose and recycle a cartridge that is configured to store and dispense at least one material the system comprising:
a cartridge having the cartridge container and the upper part, with the container and the upper part being sealingly connected to one another; and
a receptacle configured to receive and store the cartridge such that the upper part of the cartridge extends beyond an upper edge of the receptacle, the system configured to carry out the method according to claim 1.

39. The disposing and recycling system according to claim 38,
wherein the cartridge container comprises a predetermined separation section at which the upper part of the cartridge is removed.

40. The disposing and recycling system according to claim 38,
wherein the cartridge container comprises a piston configured to seal a rear end of the container and to urge material stored inside the cartridge towards the upper part.

41. The disposing and recycling system according to claim 38,
wherein the receptacle further comprises a receiving section at a bottom surface of the receptacle configured to receive the cartridge, the receiving section being configured to adjust a height between a rear end of the cartridge and the bottom surface of the receptacle.
